(19) United States
(12) Patent Application Publication
(10) Pub. No.: US 2007/0272071 A1
(43) Pub. Date: Nov. 29, 2007

(54) Flute

(76) Inventor: Michel Parmenon, Orleans (FR)

Correspondence Address: SWANSON & BRATSCHUN, L.L.C., 8210 SOUTHPARK TERRACE, LITTLETON, CO, 80120, US

(21) Appl. No.: 10/571,022

(22) PCT Filed: Sep. 2, 2004
(86) PCT No.: PCT/NL04/00609

§ 371 Date: Nov. 27, 2006

(30) Foreign Application Priority Data
Sep. 3, 2003 (NL) 1024219

(51) Int. Cl. G10D 7/02

(52) U.S. Cl. 84/384

(57) ABSTRACT

The invention relates to a flute consisting of i) a hollow resonator tube, which is open at both ends and which is provided with finger holes and keys, and ii) a hollow blow tube provided with a mouthpiece, which is open at both ends, wherein said blow tube can be coupled to the resonator tube with its open end located furthest away from the mouthpiece and wherein the open end located closest to the mouthpiece can be closed by means of a closing element that can be mounted to the blow tube. According to the invention the flute is characterized in that the flute is provided with at least one circular recess. As a result, the dynamic qualities of the flute according to the invention are improved, since the volume of the instrument is increased and the instrument is more flexible to play, especially in the high and low registers, whilst also the homogeneity of the sound is significantly improved in the high and low registers.

The invention relates to a flute consisting of i) a hollow resonator tube, which is open at both ends and which is provided with finger holes and keys, and ii) a hollow blow tube provided with a mouthpiece, which is open at both ends, wherein said blow tube can be coupled to the resonator tube with its open end located furthest away from the mouthpiece and wherein the open end located closest to the mouthpiece can be closed by means of a closing element that can be mounted to the blow tube.

The invention also relates to a blow tube and to a closing element according to the invention.

Such a flute, in particular a metal Boehm-type flute, is known, for example from U.S. Pat. No. 1,376,004. To pass the air that is blown into the blow tube via the mouthpiece by the player to the resonator tube—so as to generate sounds and tones by means of the keys—the open end of the blow tube located closest to the mouthpiece is closed by means of a closing element. Said closing element prevents the air that is blown into the tube from escaping via said—otherwise open—end and forces the air in the direction of the resonator tube. Thus the desired musical sounds and tones can be generated in the resonator tube by suitably operating (read: opening and closing) the keys that close the finger holes.

Due to the presence of such a closing element in a known blow tube, the player of the flute is “deaf” in the ear that faces away from the resonator tube, however. The closing element strongly interferes with the propagation of the sounds and tones being generated through the blow tube in the direction of the ear that faces away from the resonator tube. The flute player only perceives all the sounds and tones that are generated with the ear that faces towards the resonator tube. Flute players experience the fact that they only perceive (hear) sound and thus the dynamic qualities of the musical instrument on one side (ear) as a considerable handicap as regards their perception of the music.

In addition, the quality of the sound characteristic of such a known flute is considered to be less.

The object of the present invention is to overcome the above drawbacks and to provide a flute that has an improved sound characteristic.

According to the invention, the flute is to that end characterized in that at least one circular recess is present in the outer surface of the closing element. Experiments have shown that such a circular recess functions as a sound or resonance space/chamber, which passes the sounds and tones generated in the resonator tube to the other “deaf” ear of the flute player. Thus the player of a flute according to the invention hears the music that he/she is playing on both sides, which significantly enhances the player's overall perception of the music.

More specifically, the dynamic qualities of the flute according to the invention are improved. Especially in the high and low registers the volume of the instrument is increased and the instrument is more flexible to play, whilst also the homogeneity of the sound is significantly improved in the high and low registers.

Furthermore a flute having an improved sound characteristic/spectrum is obtained as a result of the presence of one or more circular recesses in the closing element. The recesses, which function as resonance chambers, further improve the dynamic qualities of the flute.

In a specific embodiment, the plane formed by the circular recess extends perpendicularly to the longitudinal direction of the blow tube. More specifically, the width of the recess is smaller than, equal to or greater than the width of the portion of the closing element that is located between said recesses.

In a specific embodiment of the invention, in which the closing element comprises one or more resonance chambers, the recess terminates near the central axis of the closing element.

In another very functional embodiment, the closing element according to the invention consists of two or more annular elements provided with a central bore, which elements are arranged in spaced-apart relationship around a support pin extending in the direction of the longitudinal axis of the body tube. Spacers may be provided between said annular elements. The space or recess present between two adjacent spacers also functions as a resonance chamber, which passes the sounds generated in the resonator tube to the more or less “deaf” ear, which may or may not take place via successive resonance chambers.

In the very functional embodiment, each annular element is integral with a spacer. This makes it possible to fit the closing element with a larger or smaller number of element-spacer assemblies, which in turn significantly enhances the intensity (volume) and the extent of the sound spectrum in particular in the high and low registers, and consequently further improves the sound characteristic of the flute.

To enable a quick assembly and, more importantly, a quick adjustment of the closing element in the blow tube, the support pin is according to the invention at least partially provided with screw thread to mate with a screw cap, which can be fitted round the open end located nearest to the mouthpiece.

The invention also relates to a blow tube as described above.

The invention furthermore relates to a closing element as described above.

The invention will now be explained in more detail with reference to the drawing, in which:

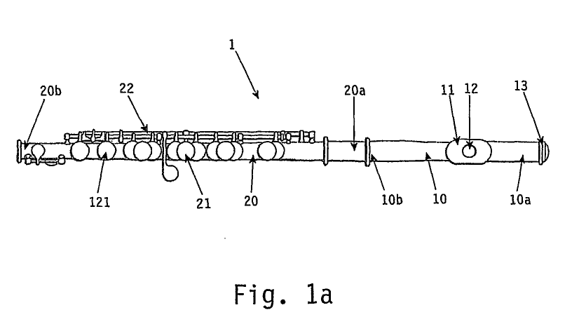

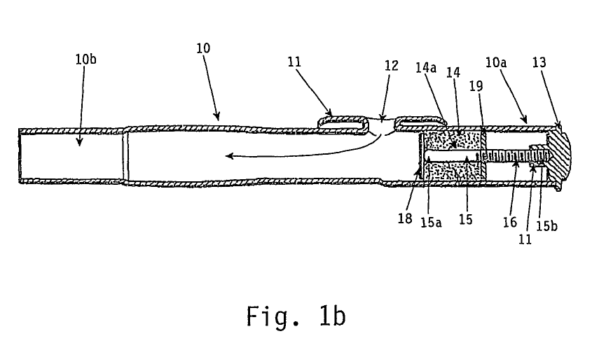

FIG. 1a shows an embodiment of the flute according to the prior art;

FIG. 1b shows an embodiment of a blow tube according to the prior art;

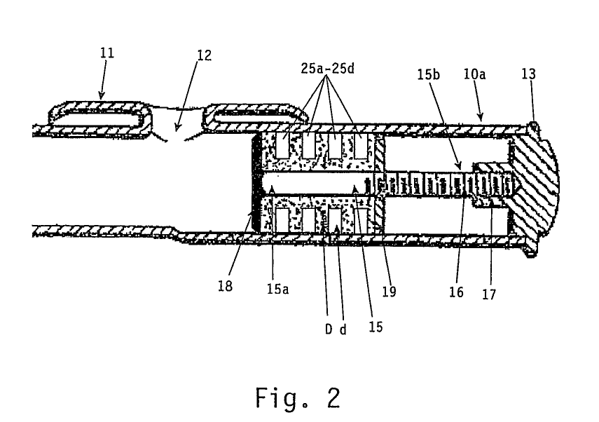

FIG. 2 shows a first embodiment of a blow tube according to the invention;

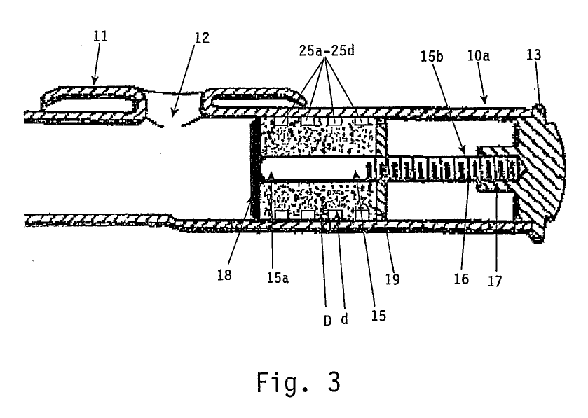

FIG. 3 shows a second embodiment of a blow tube according to the invention; and

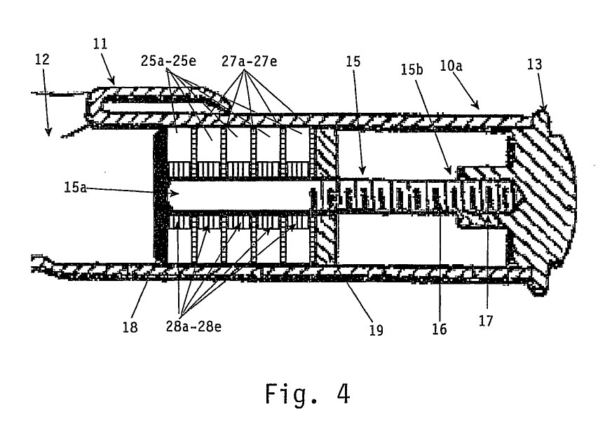

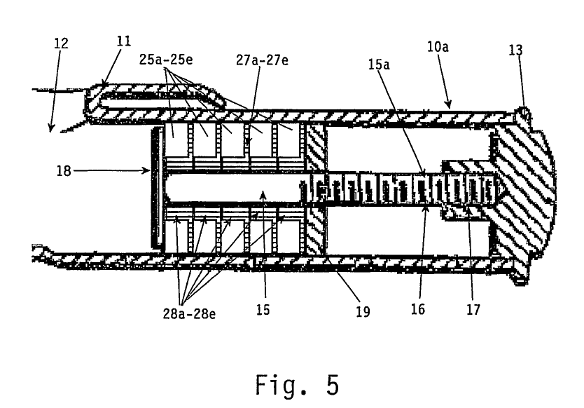

FIGS. 4 and 5 show a third and a fourth embodiment of a blow tube according to the invention.

FIG. 1a shows a Boehm-type flute, which is known per se. The known flute 1 comprises a blow tube 10 having open ends 10a and 10b, respectively. The blow tube 10 has a mouthpiece 11 provided with a blow hole 12. The blow tube 10 can be connected to the open end 20a of a resonator tube 20 with its open end 10b located furthest away from the mouthpiece 11. The resonator tube 20 has another open end 20b, and furthermore comprises several finger holes (not shown), which the player can open or close by means of suitable keys 21 via levers 22.

Thus, sounds or tones can be generated by blowing air into the blow tube 10 via the mouthpiece 11, which air finds its way out through the open end 20b of the resonator tube 20 or through the open holes and keys 21.

To prevent the air that has been blown in via the mouthpiece 11 from leaving the flute 1 via the open end 10a of the blow tube 10, said open end 10a, which is located closest to the mouthpiece 11, can be closed by means of a closing element (not shown in FIG. 1a) and a cap 13.

The cross-sectional view of FIG. 1 of a blow tube that is known per se shows the closing element 14, which is configured as a fixed cylindrical member 14 in this embodiment. Usually the closing element 14 has an external dimension which is substantially the same as the internal dimension of the cylindrical blow tube 10.

To prevent the air that is blown in via the mouthpiece 11 from exiting the flute 1 via the open end 10a of the blow tube 10, said open end 10a, which is located closest to the mouthpiece 11, can be closed by means of a closing element (not shown in FIG. 1a) and a cap 13.

The known blow tube that is shown in the cross-sectional view of FIG. 1b shows the closing element 14, in this case in the form of a fixed cylindrical member 14. Generally the external dimension of the closing element 14 is substantially the same as the internal dimension of the cylindrical blow tube 10.

It is known to use cork for forming the closing element 14 as it is currently used. The elongated cylindrical closing element 14 is provided with a longitudinal central bore 14a, which central bore 14a makes it possible to place the closing element 14 on a support pin 15. The support pin 15 is provided with an end plate 18 at its end 15a facing towards the mouthpiece 11, which end plate likewise has an external dimension which is substantially the same as the internal dimension of the cylindrical blow tube 10.

More specifically, the support pin 15 is at least partially provided with screw thread 16 near its other free end 15b, which external screw thread 16 can mate with internal screw thread 17 of the cap 13 that is likewise shown in FIG. 1. After the closing element 14 has been introduced into the blow tube 10, it can be positioned or fixed in the blow tube 10 by means of the support pin 15 and a cap 13 and completely close the free open end 10a of the blow tube.

As described above, the configurations of blow tubes fitted with such a closing element that are currently known have this drawback that the flute player can only perceive the dynamic qualities of the instrument and/or the music he/she is playing to a limited extent. In fact each flute player is more or less “deaf” in the ear that faces from the resonator tube 12 while playing. This “deafness” in one ear while playing a flute leads to the flute player experiencing a less complete perception of the music.

FIG. 2 shows a first embodiment of the blow tube according to the invention. For a better understanding of the invention, like parts are indicated by the same numerals.

According to the invention, the closing element 14 comprises one or more (four in FIG. 2) recesses 25a-25d that are circumferentially provided in the closing element 14. Said recesses 25a-25d function as resonance chambers, as in this embodiment the sound generated in the resonator tube is also passed to the “deaf” ear via the blow tube 10 and the recesses 25a-25d. As a result, the flute player experiences a different, improved perception of the music, since the dynamic qualities of instrument have been improved.

The sound characteristic or the tone spectrum of the flute according to the invention is improved as the volume in particular in the high and low registers is increased, whilst also the homogeneity of the instrument in the high and low registers is improved.

The depth of the recesses 25a-25b may be selected at will in dependence on their influence on the sound characteristic of the flute. A further significant improvement of the sound characteristic or the tone spectrum of the flute according to the invention can be achieved in that said recesses extend almost until the central opening 14a, as is shown in FIG. 2. These “deeper” recesses 25a-25d thus form larger resonance chambers, which in turn improve the sound characteristic of the instrument.

In the embodiment that is shown in FIG. 3, the recesses 25a-25d have only been formed to a small depth in the closing element 14.

Yet another embodiment is shown in FIG. 4, in which the closing element 14 consists of two or more annular elements 27a-27e, which annular elements 27a-27e are provided with a central opening 26, wherein said annular elements 27a-27e are arranged by means of spacers 28a-28e round the support pin 15 that extends in the direction of the longitudinal axis of the blow tube 10. Also in this case the spaces 25a-25e between adjacent annular elements function as sound chambers or resonance chambers for enhancing and/or improving the sounds and/or tones that are generated in the resonator tube 12.

With this embodiment, too, a flute is realised which has a considerably fuller sound as regards spectrum and volume, in particular in the high and low registers.

FIG. 5 shows yet another embodiment of the invention. The embodiment that is shown in FIG. 5 has been derived from the embodiment that is shown in FIG. 4, since each spacer 28a-28e and each annular element 27a-27e is made as a separate component in this embodiment. This makes it possible to form the closing element 14 of a succession of random number of spacers 28 and annular elements 27 or of several element-spacer assemblies according to the requirements of the owner/player of the flute. The sound or resonance chambers 25a-25e thus created lead to an improved sound characteristic as regards spectrum and volume, in particular in the high and low registers.

Both the spacers 28a-28e and the annular elements 27a-27e as well as the assemblies thereof can simply be made of a plastic material. This makes it possible to produce the annular elements and/or the spacers and/or the assemblies thereof in large numbers at a low cost price. More in particular, the external diameter of the annular element is substantially the same as the internal diameter of the blow tube. Preferably, however, the annular element has an external dimension which is slightly smaller than the internal dimension of the cylindrical blow tube. This enables the annular elements to undergo a resonating movement, which has a further positive effect on the sound spectrum of the flute.

In the embodiment as described above the width d of each recess/chamber may be smaller than, identical to or larger than the width/thickness D of the directly adjacent portion of the material of the closing element 14 or the thickness of the annular element 27a-27e.

Furthermore it should be noted that the invention can be suitably applied not only in flutes, but also in piccolos, alto flutes and bass flutes.

1. A flute comprising:
i) a hollow resonator tube, which is open at both ends and which is provided with finger holes and keys, and
ii) a hollow blow tube provided with a mouthpiece, which is open at both ends, wherein said blow tube can be coupled to the resonator tube with its open end located furthest away from the mouthpiece and wherein the open end located closest to the mouthpiece can be closed by means of a closing element that can be mounted in the blow tube, wherein the closing element is provided with at least one circular recess.

2. The flute according to claim 1, wherein a plane defined by the circular recess extends perpendicularly to a longitudinal direction of the blow tube.

3. The flute according to claim 1 wherein the closing element is provided with more than one circular recess and the width of at least one circular recess is less than the width of a portion of the closing element that is located between said recesses.

4. The flute according to claim 1 wherein the closing element is provided with more than one circular recess and the width of at least one circular recess is equal to the width of the portion of the closing element that is located between said recesses.

5. The flute according claim 1 wherein the closing element is provided with more than one circular recess and the width of at least one circular recess is greater than the width of the portion of the closing element that is located between said recesses.

6. The flute according to claim 1 wherein the circular recess terminates near the central axis of the closing element.

7. The flute according to claim 1 wherein the closing element comprises two or more annular elements provided with a central bore, which annular elements are arranged in spaced-apart relationship around a support pin extending in the direction of a longitudinal axis of the blow tube.

8. The flute according to claim 7, wherein spacers are provided between said annular elements.

9. The flute according to claim 8, wherein each annular element is integral with a spacer.

10. The flute according to claim 7, wherein the support pin is at least partially provided with screw thread to mate with a screw cap, which can be fitted to an open end located nearest to the mouthpiece.

11. A closing element for mounting in a blow tube of a flute, comprising:
a support pin;
an end plate associated with the support pin at a first end facing the mouthpiece of a flute;
screw thread associated with the support pin opposite the end plate;
a cap threadably engaged with the screw thread of the support pin; and
at least one circular recess defined by the closing element between the end plate and the cap.

12. A closing element for mounting in a blow tube of a flute, comprising:
a support pin;
an end plate associated with the support pin at a first end facing the mouthpiece of a flute;
screw thread associated with the support pin opposite the end plate;
a cap threadably engaged with the screw thread of the support pin; and
at least one recess defined by the closing element between the end plate and the cap.
